(19) United States
(12) Patent Application Publication
(10) Pub. No.: US 2025/0258374 A1
(43) Pub. Date: Aug. 14, 2025

(54) INFORMATION PROCESSING APPARATUS CAPABLE OF ESTIMATING OCCURRENCE OF VISUALLY INDUCED MOTION SICKNESS FROM COMPONENTS OF HMD, CONTROL METHOD FOR INFORMATION PROCESSING APPARATUS, AND STORAGE MEDIUM

(71) Applicant: CANON KABUSHIKI KAISHA, Tokyo (JP)

(72) Inventor: KOUSHI TAKEMURA, Kanagawa (JP)

(21) Appl. No.: 19/017,024

(22) Filed: Jan. 10, 2025

(30) Foreign Application Priority Data
Feb. 8, 2024 (JP) 2024-017796

(51) Int. Cl. G02B 27/01; G06T 19/00

(52) U.S. Cl. CPC G02B 27/017; G06T 19/006

(57) ABSTRACT

An information processing apparatus capable of estimating an occurrence of a visually induced motion sickness from components of an HMD is provided. The information processing apparatus includes one or more processors and/or circuitry configured to execute an HMD information obtainment processing that obtains HMD configuration information indicating a relationship between components of an HMD and a visually induced motion sickness, execute an estimation processing that estimates whether or not a user using the HMD experiences the visually induced motion sickness based on an induction degree of the visually induced motion sickness obtained by using the HMD configuration information, and execute an output processing that outputs an estimation result obtained in the estimation processing.

### BACKGROUND OF THE INVENTION

### Field of the Invention

The present invention relates to an information processing apparatus, a control method for the information processing apparatus, and a storage medium.

### Description of the Related Art

In recent years, a head mounted display to be worn on a user's head (hereinafter, referred to as “an HMD”) has become widespread, and it has become possible to easily experience an immersive extended reality/cross reality content (an immersive XR content) by using an HMD. There are various types of HMDs, including, for example, a stand-alone type that is used independently, and an external device connection type that is used by connecting to a personal computer (a PC), a smartphone, or the like. In addition, a display viewing angle, a refresh rate, a display resolution, etc. of the HMD that displays the XR content also differ depending on the type of the HMD.

Incidentally, since an HMD is a device that presents video images by widely covering a field of view, a user who is using an HMD may experience a visually induced motion sickness, which is similar to a motion sickness and includes headaches, dizziness, nausea, and the like. The visually induced motion sickness has been said to be caused by a number of factors, including components of the HMD that affect the performance of the HMD, the contents of the XR content, and the characteristics of the user. Japanese Laid-Open Patent Publication (kokai) No. 2021-51756 has disclosed a technique that uses a learning model to detect a virtual reality content (a VR content) that may induce discomfort and nausea that are equivalent to the visually induced motion sickness.

However, the technique disclosed in Japanese Laid-Open Patent Publication (kokai) No. 2021-51756 does not use the components of the HMD as learning data, so there has been an issue that it is not possible to support various types of HMDs.

### SUMMARY OF THE INVENTION

The present invention provides an information processing apparatus capable of estimating an occurrence of a visually induced motion sickness from components of an HMD, a control method for the information processing apparatus, and a storage medium.

Accordingly, the present invention provides an information processing apparatus comprising one or more processors and/or circuitry configured to execute an HMD information obtainment processing that obtains HMD configuration information indicating a relationship between components of an HMD and a visually induced motion sickness, execute an estimation processing that estimates whether or not a user using the HMD experiences the visually induced motion sickness based on an induction degree of the visually induced motion sickness obtained by using the HMD configuration information, and execute an output processing that outputs an estimation result obtained in the estimation processing.

According to the present invention, it is possible to estimate the occurrence of the visually induced motion sickness from the components of the HMD.

Further features of the present invention will become apparent from the following description of exemplary embodiments with reference to the attached drawings.

### BRIEF DESCRIPTION OF THE DRAWINGS

FIG. 1 is a diagram that shows a user who has worn an information processing apparatus, and a virtual space, etc. that have been displayed on the information processing apparatus.

FIG. 2 is a block diagram that shows an example of a hardware configuration of the information processing apparatus.

FIG. 3 is a functional block diagram that shows an example of a functional configuration of the information processing apparatus.

FIG. 4 is a diagram that shows an example of a feature quantity history table.

FIG. 5 is a flowchart that shows an example of the flow of a trained model generation processing.

FIG. 6 is a flowchart that shows an example of the flow of a visually induced motion sickness induction estimation processing.

### DESCRIPTION OF THE EMBODIMENTS

The present invention will now be described in detail below with reference to the accompanying drawings showing embodiments thereof.

Hereinafter, embodiments of the present invention will be described in detail with reference to the accompanying drawings. However, the configuration described in each of the following embodiments is merely an example, and the scope of the present invention is not limited by the configuration described in each of the following embodiments. For example, each unit (each part) constituting the present invention can be replaced with a unit (a part) having an arbitrary configuration capable of exhibiting a similar function. In addition, arbitrary component(s) may be added. Furthermore, any two or more configurations (features) of each of the following embodiments may be combined. Moreover, not all of the combinations of features described in each of the following embodiments are necessarily essential to the solving means of the present invention. The configuration of each of the following embodiments may be modified or changed as appropriate depending on the specifications of an apparatus to which the present invention is applied and various conditions (usage conditions, a usage environment, etc.). It should be noted that in each of the following embodiments, the same components are denoted by the same reference numerals in the following description.

### First Embodiment

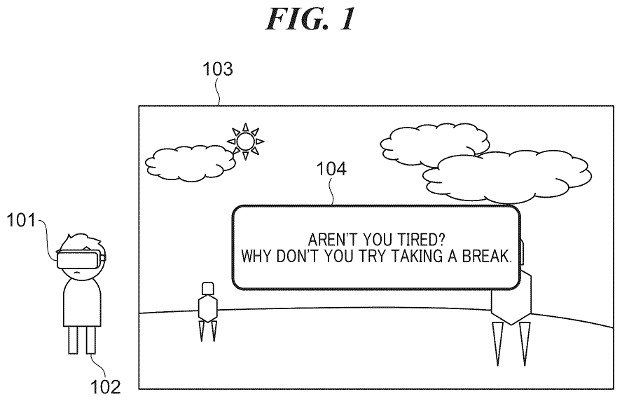

Hereinafter, a first embodiment will be described with reference to FIGS. 1 to 6. Here, as an example of estimating an occurrence of a visually induced motion sickness and notifying a user, a scene, in which the user is encouraged to take a break through an HMD worn by the user, will be described with reference to FIG. 1. FIG. 1 is a diagram that shows a user 102 who has worn an information processing apparatus 101, and a virtual space 103, etc. that have been displayed on the information processing apparatus 101. As shown in FIG. 1, the information processing apparatus 101 is a head-mounted type HMD. The HMD is of a non-transmissive type, but is not limited to this, and may be of an optically transmissive type or a video transmissive type. It should be noted that the concept of “the HMD” in the present invention includes smart glasses. Therefore, the information processing apparatus 101 is not limited to a head-mounted type HMD, and may be, for example, eyeglass-type smart glasses.

In addition, the information processing apparatus 101 is a stand-alone type HMD, but is not limited to the stand-alone type HMD, and may be, for example, an external device connection type HMD. The external device connection type HMD is, for example, an electronic device such as a PC, a tablet, or a smartphone that has been connected to an HMD or smart glasses. An XR content that the user 102 experiences via the information processing apparatus 101 has been displayed in the virtual space 103. In the case that the information processing apparatus 101 has estimated an occurrence of a visually induced motion sickness in the user 102, the information processing apparatus 101 displays a message 104 within the virtual space 103 to encourage the user 102 to take a break.

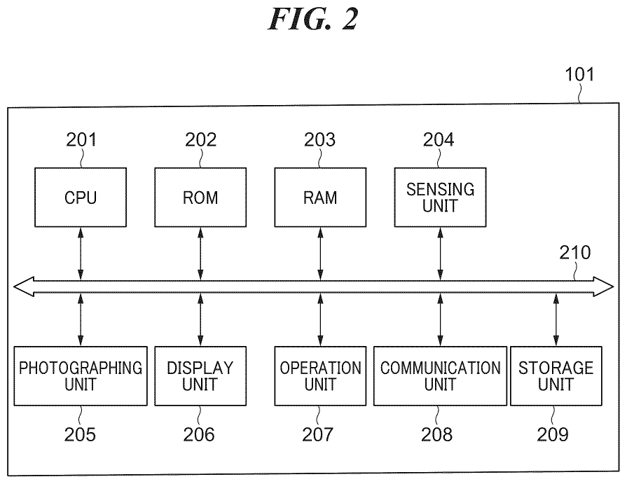

The configuration and operations of the information processing apparatus 101 will be described below. FIG. 2 is a block diagram that shows an example of a hardware configuration of the information processing apparatus 101. As shown in FIG. 2, the information processing apparatus 101 includes, as components, a central processing unit (a CPU) 201, a read only memory (a ROM) 202, a random access memory (a RAM) 203, a sensing unit 204, a photographing unit 205, a display unit 206, an operation unit 207, a communication unit 208, and a storage unit 209. The respective components of the information processing apparatus 101 are connected to each other via a bus 210. The CPU 201 is an arithmetic processing device that comprehensively controls the information processing apparatus 101. The CPU 201 executes various kinds of programs that have been stored in the ROM 202 and the like to perform various kinds of processing. The ROM 202 is a read-only nonvolatile memory device that stores programs (such as image processing programs and initial data) and parameters that do not require modification.

Input information, calculation results in image processing, and the like are temporarily stored in the RAM 203. In addition, the RAM 203 is a memory device that provides a working area for the CPU 201. The sensing unit 204 is a device that includes sensors and the like. The sensing unit 204 obtains position and posture information of the user 102 who is a user of the information processing apparatus 101 by detecting a rotation, a tilt, a movement amount, and the like of the head. In addition, the sensing unit 204 obtains information such as eye tracking, an eye movement, the number of times of eye closures (the number of times of closing eyes), an eye closure time, a body temperature, a skin moisture content, brain waves, a heart rate, etc. of the user 102 who is the user of the information processing apparatus 101 by using an infrared sensor, a physiological sensor, and the like. The photographing unit 205 is a photographing device such as a camera built into the HMD, and performs a photographing processing. It should be noted that in the case that the information processing apparatus 101 is of an external device connection type, the photographing unit 205 also includes a web camera or the like that has been connected to a PC or the like.

The display unit 206 is a liquid crystal display or the like. The display unit 206 displays captured images, virtual objects, characters, items, and the like. The operation unit 207 is an operating unit that includes an operation member such as a power button or a dial. It should be noted that in the case that the information processing apparatus 101 is of an external device connection type, the operating unit of the operation unit 207 also includes a keyboard, a mouse, and the like. The communication unit 208 transmits and receives data to and from external apparatus(es) via wired communication or wireless communication (for example, a wireless LAN or local 5G). It should be noted that in the case that the information processing apparatus 101 is of an external device connection type, the communication unit 208 is capable of receiving information and the like that are obtained by the sensing unit 204 of the HMD via a network. The storage unit 209 is a readable/writable nonvolatile memory device, and stores various kinds of data, various kinds of programs, etc., as well as a feature quantity history table and a trained model, which will be described below.

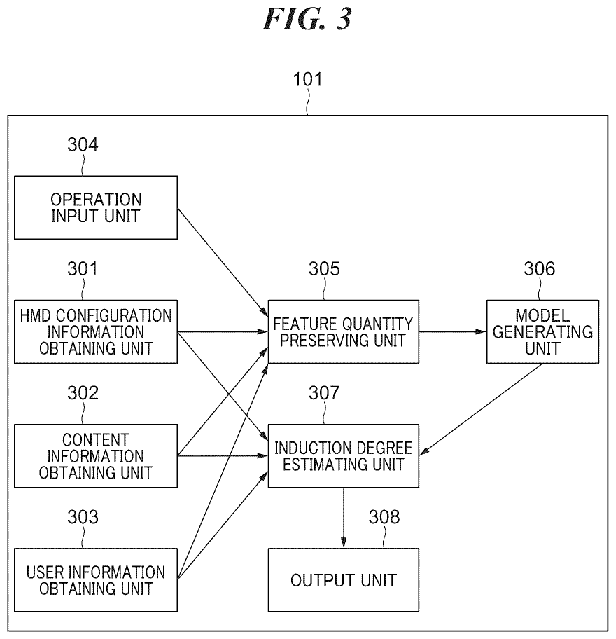

FIG. 3 is a functional block diagram that shows an example of a functional configuration of the information processing apparatus 101. As shown in FIG. 3, the information processing apparatus 101 includes an HMD configuration information obtaining unit 301, a content information obtaining unit 302, a user information obtaining unit 303, an operation input unit 304, a feature quantity preserving unit 305, a model generating unit 306, an induction degree estimating unit 307, and an output unit 308. As described above, each of functions shown in FIG. 3 is able to be realized by the CPU 201 executing a program, but it is not necessary for the CPU 201 to realize all the functions through the programs. For example, the information processing apparatus 101 may include dedicated processing circuitry for implementing one or more functions.

The HMD configuration information obtaining unit 301 (an HMD information obtaining unit) obtains HMD configuration information, which indicates a relationship between the components of the HMD and the visually induced motion sickness, from the information processing apparatus 101. The HMD configuration information will be described in detail below. The content information obtaining unit 302 (a content information obtaining unit) obtains content information, which indicates a relationship between the XR content and the visually induced motion sickness, from the XR content displayed on the display unit 206 of the information processing apparatus 101. The content information will be described in detail below.

The user information obtaining unit 303 (a user information obtaining unit) obtains user information, which indicates a relationship between the user and the visually induced motion sickness, from user information that has been stored in advance in the RAM 203, the storage unit 209, or the like. Furthermore, the user information obtaining unit 303 obtains the position and posture information of the user 102 from the sensing unit 204 as the user information. The user information will be described in detail below. It should be noted that the user information obtaining unit 303 also obtains user's physiological information from the sensing unit 204. The operation input unit 304 (an operation obtaining unit) obtains, from the operation unit 207, information inputted by the user. The information inputted by the user will be described in detail below. The feature quantity preserving unit 305 stores and preserves, in the storage unit 209 or the like as the feature quantity history table, the HMD configuration information, the content information, the user information, the user's physiological information, and the information inputted by the user.

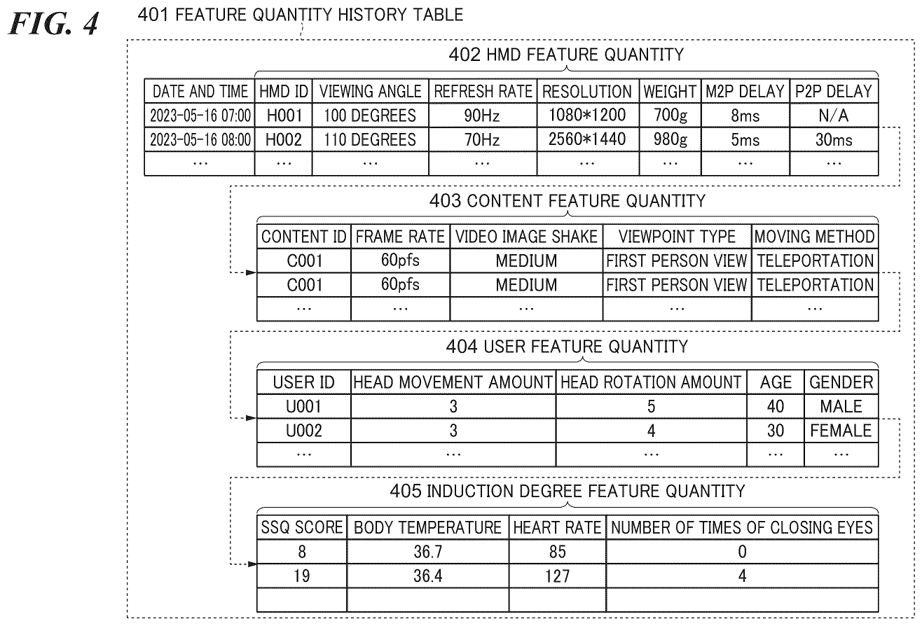

FIG. 4 is a diagram that shows an example of a feature quantity history table 401. As shown in FIG. 4, in the feature quantity history table 401, a date and time column stores a date and time when the record has been preserved by the feature quantity preserving unit 305. An HMD feature quantity 402 is the HMD configuration information that has been obtained by the HMD configuration information obtaining unit 301. In the HMD feature quantity 402, an HMD ID column stores information such as a number that is capable of uniquely identifying the type of the HMD. A viewing angle column stores the value of a display viewing angle of the HMD. It has been known that the wider the display viewing angle of the HMD, the more likely it is to cause spontaneous movement vection (visually induced self-motion sensation) which is thought to be related to the visually induced motion sickness. In addition, due to visual characteristics, the user is more likely to notice flicker in a peripheral visual field, and in the case that a refresh rate is low and a brightness is high, the perception of flicker may lead to the visually induced motion sickness.

A refresh rate column stores the value of a refresh rate of the HMD. The refresh rate, and a frame rate (described below), are closely related to flicker, and it has been said that slower rates are more likely to lead to the visually induced motion sickness. A resolution column stores the value of a display resolution of the HMD. Even in the case that the display resolution of the HMD is high, if the refresh rate or tracking performance is low, it has been said that a mismatch in sensation will be large, which can easily lead to the visually induced motion sickness. A weight column stores the value of a weight of the HMD. It has been said that if the HMD is heavy, it puts a greater strain on the user's body and is more likely to lead to the visually induced motion sickness.

An M2P delay column stores the value of a delay time until the user's movement is reflected on the display of the HMD, called “motion to photon delay (hereinafter, referred to as “M2P delay”)”. It has been said that if the value of the M2P delay is large, it is more likely to lead to the visually induced motion sickness. A P2P delay column stores the value of a delay time called “photon to photon delay (hereinafter, referred to as “P2P delay”)”, which is a time from when light (a real-photographed video image) enters the camera of the HMD to when it is displayed as a background image on the display of the HMD. It has been said that if the value of the P2P delay is large, it is more likely to lead to the visually induced motion sickness. It should be noted that in the case that the HMD does not have the function of displaying the real-photographed video image as the background image, “N/A” is stored in the P2P delay column.

In addition, the HMD configuration information, which indicates the relationship between the components of the HMD and the visually induced motion sickness, may be stored in the feature quantity history table 401. For example, it has been said that if the tracking performance of the position and posture of the HMD, a controller, hands, etc. is low, the sense of incongruity with reality will be strong and it will easily lead to the visually induced motion sickness, so the tracking performance may be stored. In addition, since it has been said that if there is a difference between the user's interpupillary distance and the HMD's interpupillary distance, a convergence angle with respect to the object the user is looking at becomes large, which can easily lead to the visually induced motion sickness, the presence or absence of a function to set the HMD's interpupillary distance may be stored. In addition, the strength of a lens distortion, a display afterglow property, the presence or absence of a function to reduce the visually induced motion sickness (hereinafter, referred to as “a visually induced motion sickness reduction function”), etc. may be stored. It should be noted that in the above description, the columns of the HMD feature quantity 402 store the information expressed by the functions of the HMD, but the names of the components that implement these functions (including the names of modules) may be stored.

A content feature quantity 403 is the content information that has been obtained by the content information obtaining unit 302. In the content feature quantity 403, a content ID column stores information such as a number that is capable of uniquely identifying the type of the XR content. A frame rate column stores the value of a frame rate of the XR content. The frame rate, like the refresh rate described above, has been said to be related to the visually induced motion sickness. A video image shake column stores the degree of movement of the position and posture of the user's viewpoint that is expected while experiencing the XR content. The degree of the movement of the position and posture of the user's viewpoint is indicated by notation such as “large, medium, small”, but may be indicated by, for example, a continuous value such as a range of 0 to 10 points. It has been known that the greater the video image shake, the more likely it is to lead to the visually induced motion sickness.

A viewpoint type column stores a value, which indicates whether the XR content is from a first person viewpoint of an avatar or a third person viewpoint of the avatar. The first person viewpoint is more immersive than the third person viewpoint, and is therefore more prone to sensory mismatches, which has been said to lead to the visually induced motion sickness. A movement method column stores a value, which indicates a movement method of the avatar in the XR content. Examples of the movement method include teleportation by operating the controller or by hand interaction, continuous movement, and forced movement by sitting in a driver's seat. It has been known that vection can be easily caused by sensory mismatch depending on the movement method.

In addition, the content information, which indicates the relationship between the XR content and the visually induced motion sickness, may be stored in the feature quantity history table 401. For example, a value indicating a moving speed of the avatar or a value indicating a moving acceleration of the avatar may be stored. In addition, the presence or absence of a visual guidance function when the avatar moves, the presence or absence of a tunneling function when the avatar moves, and the presence or absence of the visually induced motion sickness reduction function when the avatar moves may be stored as values.

A user feature quantity 404 is the user information that has been obtained by the user information obtaining unit 303. In the user feature quantity 404, a user ID column stores information such as a number that is capable of uniquely identifying the user. A head movement amount column stores the value of a change amount of the position of the HMD over a certain period of time. The value of the change amount of the position of the HMD is expressed as a continuous value such as a range of 0 to 10 points, but may be expressed as, for example, a three-dimensional vector of position. It has been known that the greater the head movement amount in a certain period of time, the more likely it is to lead to the visually induced motion sickness.

A head rotation amount column stores the value of a change amount of the rotation of the HMD over a certain period of time. The value of the change amount of the rotation of the HMD is expressed as a continuous value such as a range of 0 to 10 points, but may be expressed as, for example, a three-dimensional vector of rotation. It has been known that the greater the head rotation amount in a certain period of time, the more likely it is to lead to the visually induced motion sickness. An age column stores the value of the user's age. It has been said that a tendency to experience the visually induced motion sickness (susceptibility to the visually induced motion sickness) is most prevalent among people aged between 2 and 12, decreases until around age 21, and then increases again after the age of 50. A gender column stores a value indicating the gender of the user. It has been said that women are more susceptible to the visually induced motion sickness than men.

In addition, the user information, which indicates the relationship between the user and the visually induced motion sickness, may be stored in the feature quantity history table 401. For example, a value indicating information that is considered to be related to the visually induced motion sickness, such as a race or a health condition, may be stored. In addition, a value indicating a use frequency of the HMD of the user and a value indicating a use time of the HMD of the user may be stored. It has been said that as the users repeatedly experiences the HMD, his or her brain becomes accustomed to it and is able to adapt, reducing the visually induced motion sickness. The use frequency of the HMD and the use time of the HMD may be tallied by the type of the HMD or by the type of the XR content.

An induction degree feature quantity 405 is the user's physiological information and the information inputted by the user, and corresponds to an induction degree of the visually induced motion sickness. The user's physiological information is obtained by the user information obtaining unit 303 via the sensing unit 204. The information inputted by the user is obtained by the operation input unit 304 via the operation unit 207. An SSQ score column stores an SSQ score value that is calculated by using a psychological questionnaire-style measurement method called “Simulator Sickness Questionnaire (hereinafter, referred to as “SSQ”)”, which is used in the subjective evaluation of the visually induced motion sickness. The user experiencing the XR content on the information processing apparatus 101 answers the SSQ via the operation unit 207.

A body temperature column stores the value of the user's body temperature, and a heart rate column stores the value of the user's heart rate. It has been said that the physical discomfort caused by the visually induced motion sickness causes the body temperature and the heart rate to rise. It should be noted that in the first embodiment, the actual measured values of the body temperature and the heart rate that are obtained by the sensing unit 204 are used as an example, and however, actual measurements of the body temperature and the heart rate may be performed during normal times without wearing the HMD, and the differences from the normal times may be stored in the feature quantity history table 401. A column of the number of times of eye closures stores the value of the number of times of eye closures or an eye closure time of the user over a certain period of time. It has been said that the user closes his or her eyes due to the physical discomfort caused by the visually induced motion sickness.

In addition, the input information and the user's psychological or physiological information that are considered to be related to the visually induced motion sickness may be stored in the feature quantity history table 401. For example, values indicating the information that is considered to be related to the visually induced motion sickness, such as the skin moisture content, the brain waves, and a mismatch between the eye movement and an HMD video image, may be stored. In addition, a unique index value that combines the SSQ score and other physiological index values may be defined and stored.

Returning to the description of FIG. 3. The model generating unit 306 (a model generating unit) uses the feature quantity history table 401 as learning data and trains a previously prepared untrained or partially trained learning model to generate a trained model that obtains the induction degree of the visually induced motion sickness. In other words, the model generating unit 306 generates the trained model that estimates the induction degree by machine learning using at least one or more of the HMD feature quantity 402, the content feature quantity 403, and the user feature quantity 404 as explanatory variables and using one of the induction degree feature quantity 405 as a response variable (an objective variable). The relationship between the induction degree, which is the response variable (the objective variable), and the other explanatory variables is expressed, for example, by the following Expression (hereinafter, referred to as “Expression 1”).

$$the induction degree = β 0 + ( the display viewing angle ) \times β1 + ( the refresh rate ) \times β2 + ( the display resolution ) \times β3 + ( the weight ) \times β4 + … \qquad [ Expression 1 ]$$

Here, βn (n=0, 1, 2, 3, 4, . . . ) are coefficients determined in the trained model. Expression 1 is an equation showing a trained model generated by machine learning using a linear regression model, but the machine learning using a linear regression model is merely one example, and the machine learning method is not limited to this. Specifically, for example, the trained model may be generated by machine learning using a method other than a linear regression model, such as a support vector machine (SVM). In addition, the model generating unit 306 may divide into predetermined categories such as by the HMD, by the XR content, by the user, or by the health condition and generate a plurality of trained models. The model generating unit 306 stores and preserves the generated trained model in the storage unit 209 or the like.

The induction degree estimating unit 307 first inputs the explanatory variables into the trained model generated by the model generating unit 306, and obtains the induction degree outputted by the trained model. The explanatory variables include the HMD configuration information obtained by the HMD configuration information obtaining unit 301, the content information obtained by the content information obtaining unit 302, and the user information obtained by the user information obtaining unit 303. Next, the induction degree estimating unit 307 (an estimating unit) compares the obtained induction degree with a predetermined threshold value, and estimates whether or not the user is experiencing the visually induced motion sickness.

The output unit 308 (an output unit) generates notification information based on an estimation result obtained by the induction degree estimating unit 307, and outputs the generated notification information to the display unit 206. At this time, the output unit 308 may change the content of the notification information to be generated depending on the estimation result obtained by the induction degree estimating unit 307. For example, the output unit 308 changes the content of the notification information to be generated depending on the magnitude of the induction degree obtained by the induction degree estimating unit 307. In the case that the induction degree is a value equivalent to a mild level, the output unit 308 generates and outputs, for example, as shown in FIG. 1, the notification information with the content of “Aren't you tired? Why don't you try taking a break.”. In addition, in the case that the induction degree is a value equivalent to a severe level, the output unit 308 generates and outputs, for example, the notification information with the content of “You appear to be unwell. Please stop the content immediately and take a break.”.

In addition, the output unit 308 (a reducing unit) may execute the visually induced motion sickness reduction function that is included in the information processing apparatus 101 or the XR content, or forcibly stop the XR content itself, depending on the estimation result obtained by the induction degree estimating unit 307. For example, the output unit 308 may perform the parameter adjustment of each HMD component in the information processing apparatus 101 to reduce the display viewing angle, lower the display resolution and increase the frame rate, etc., in order to reduce the visually induced motion sickness.

It should be noted that the model generating unit 306 (a model updating unit) includes a function of updating the trained model. The model generating unit 306 updates the trained model, for example, by additionally training the generated trained model. In this case, the output unit 308 generates request information for requesting feedback of the notification result from the user, and outputs the generated request information to the display unit 206 in addition to the notification information described above. Here, the request information is information for causing the display unit 206 to output the content such as “Did you experience any symptoms of the visually induced motion sickness? This will be fed back to the induction determination.”.

The user performs an operation input indicating whether or not the visually induced motion sickness is actually occurring on the operation unit 207, thereby causing the operation input unit 304 to obtain feedback information (the input information). The model generating unit 306 updates the trained model based on the feedback information that has been obtained by the operation input unit 304. For example, in the case that the content of the feedback information is “NO” as an answer to “Did you experience any symptoms of the visually induced motion sickness?”, it can be said that the accuracy of the trained model is low. Therefore, the model generating unit 306 updates the trained model by performing supervised learning on the trained model, for example, using the feedback information that has been obtained by the operation input unit 304 as training data (supervised data).

In this way, the model generating unit 306 is able to increase the accuracy of the induction degree to be obtained from the trained model by updating the trained model. It should be noted that the user may input an appropriate induction degree when receiving a request for the feedback of the notification result. In this case, the model generating unit 306 updates the trained model so that the induction degree to be obtained from the trained model becomes the induction degree indicated by the feedback information.

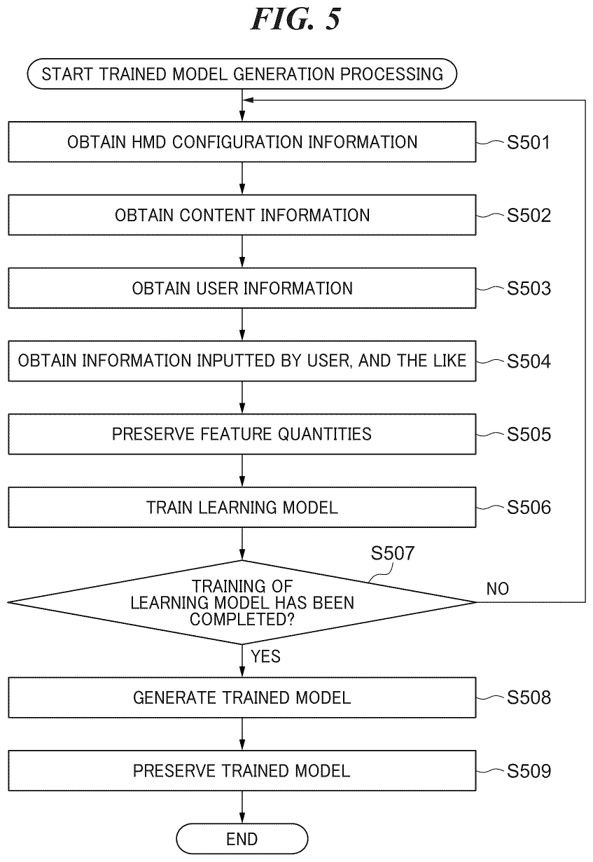

FIG. 5 is a flowchart that shows an example of the flow of a trained model generation processing. The flow of the trained model generation processing shown in the flowchart of FIG. 5 is realized by the CPU 201 loading a program stored in the ROM 202 or the storage unit 209 into the RAM 203 and executing it. In the trained model generation processing shown in the flowchart of FIG. 5, first, in a step S501, the CPU 201 causes the HMD configuration information obtaining unit 301 to obtain the HMD configuration information. In a step S502, the CPU 201 causes the content information obtaining unit 302 to obtain the content information. In a step S503, the CPU 201 causes the user information obtaining unit 303 to obtain the user information.

In a step S504, the CPU 201 causes the user information obtaining unit 303 (a measurement obtaining unit) and the operation input unit 304 (the measurement obtaining unit) to obtain the user's physiological information (biological effect information) and the information inputted by the user (the biological effect information). In a step S505, the CPU 201 causes the feature quantity preserving unit 305 to preserve, in the feature quantity history table 401, the HMD configuration information obtained in the step S501, the content information obtained in the step S502, and the user information obtained in the step S503. Furthermore, the CPU 201 causes the feature quantity preserving unit 305 to preserve, in the feature quantity history table 401, the user's physiological information and the information inputted by the user that have been obtained in the step S504. In a step S506, the CPU 201 causes the model generating unit 306 to train the previously prepared untrained or partially trained learning model. At this time, the CPU 201 causes the model generating unit 306 to use, as the learning data, the feature quantity history table 401 in which the respective pieces of information have been preserved in the step S505.

In a step S507, the CPU 201 causes the model generating unit 306 to determine whether or not training of the learning model has been completed. At this time, the CPU 201 causes the model generating unit 306 to perform the determination in the step S507 by, for example, comparing with the number of times of training, a training time, or the like that has been determined in advance. In the case that the model generating unit 306 determines that the training of the learning model has not been completed, the CPU 201 returns the trained model generation processing to the step S501. As a result, the CPU 201 repeatedly performs the respective processes from the step S501 to the step S507 until it is determined in the step S507 that the training of the learning model has been completed. On the other hand, in the case that the model generating unit 306 determines that the training of the learning model has been completed, the CPU 201 advances the trained model generation processing to a step S508.

In the step S508, the CPU 201 causes the model generating unit 306 to generate the trained model that outputs the induction degree of the visually induced motion sickness by setting the learning model that has been trained so far as the trained model. In a step S509, the CPU 201 causes the model generating unit 306 to store and preserve the trained model in the storage unit 209 or the like. After that, the trained model generation processing shown in the flowchart of FIG. 5 ends.

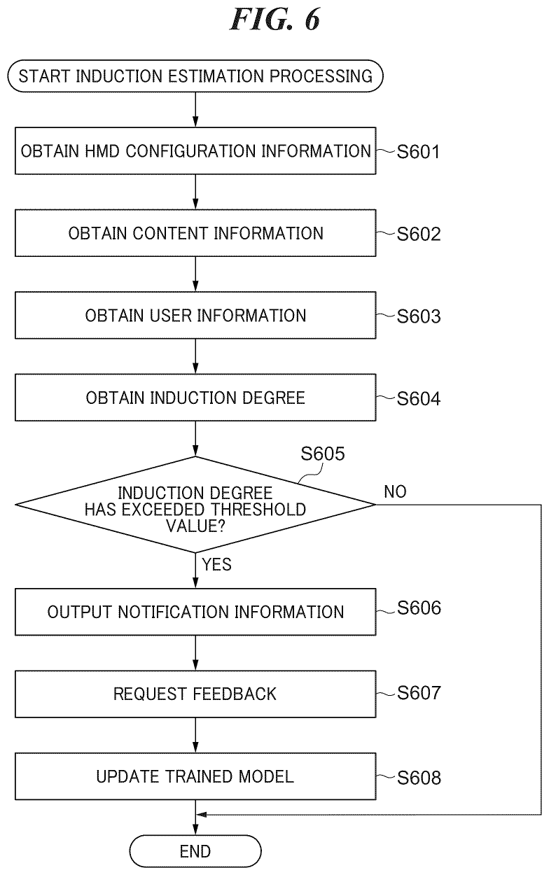

FIG. 6 is a flowchart that shows an example of the flow of a visually induced motion sickness induction estimation processing. The flow of the visually induced motion sickness induction estimation processing shown in the flowchart of FIG. 6 (a control method for the information processing apparatus) is realized by the CPU 201 (a computer) loading a program stored in the ROM 202 or the storage unit 209 into the RAM 203 and executing it. It should be noted that the visually induced motion sickness induction estimation processing shown in the flowchart of FIG. 6 is repeatedly executed, for example, every time a predetermined period of time elapses. In the visually induced motion sickness induction estimation processing shown in the flowchart of FIG. 6, first, in a step S601, the CPU 201 causes the HMD configuration information obtaining unit 301 to obtain the HMD configuration information (an HMD information obtaining step).

In a step S602, the CPU 201 causes the content information obtaining unit 302 to obtain the content information. In a step S603, the CPU 201 causes the user information obtaining unit 303 to obtain the user information. In a step S604, the CPU 201 causes the induction degree estimating unit 307 to input the information obtained in the steps S601 to S603 into the trained model and obtain the induction degree outputted by the trained model. Specifically, the CPU 201 first causes the induction degree estimating unit 307 to obtain the trained model that has been preserved in the step S509 by reading out it from the storage unit 209 or the like. Next, the CPU 201 causes the induction degree estimating unit 307 to input the information obtained in the steps S601 to S603 as the explanatory variables into the obtained trained model, thereby obtaining the induction degree to be outputted as the response variable (the objective variable).

In a step S605, the CPU 201 causes the induction degree estimating unit 307 to determine whether or not the user using the HMD is experiencing the visually induced motion sickness. Specifically, the CPU 201 causes the induction degree estimating unit 307 to determine whether or not the user using the HMD is experiencing the visually induced motion sickness by comparing the induction degree obtained in the step S604 with a predefined threshold value and determining whether or not the induction degree has exceeded the threshold value. Here, in the case that the induction degree has exceeded the threshold value, it is determined that the user using the HMD is experiencing the visually induced motion sickness, and in the case that the induction degree has not exceeded the threshold value, it is determined that the user using the HMD is not experiencing the visually induced motion sickness. In this way, in the step S605, the CPU 201 causes the induction degree estimating unit 307 to estimate whether or not the user using the HMD is experiencing the visually induced motion sickness (an estimating step). In the case that the induction degree estimating unit 307 determines that the user using the HMD is not experiencing the visually induced motion sickness, the CPU 201 ends the visually induced motion sickness induction estimation processing shown in the flowchart of FIG. 6. On the other hand, in the case that the induction degree estimating unit 307 determines that the user using the HMD is experiencing the visually induced motion sickness, the CPU 201 advances the visually induced motion sickness induction estimation processing shown in the flowchart of FIG. 6 to a step S606.

In the step S606, the CPU 201 causes the output unit 308 to generate notification information and output the generated notification information to the display unit 206 (an output step). As a result, the notification information is displayed on the display unit 206. In a step S607, the CPU 201 causes the output unit 308 to generate request information and output the generated request information to the display unit 206. As a result, the request information is displayed on the display unit 206. In this way, the CPU 201 causes the output unit 308 to request feedback from the user regarding the content of the notification information that has been outputted in the step S606. In a step S608, the CPU 201 causes the model generating unit 306 to update the trained model in accordance with the content of an answer from the user to the request for the feedback in the step S607. After that, the visually induced motion sickness induction estimation processing shown in the flowchart of FIG. 6 ends.

It should be noted that as described above, the CPU 201 repeatedly executes the visually induced motion sickness induction estimation processing shown in the flowchart of FIG. 6 after the predetermined period of time has elapsed since the end of the visually induced motion sickness induction estimation processing shown in the flowchart of FIG. 6. In addition, in the above description, the induction degree estimating unit 307 has been described as determining whether or not the user using the HMD is experiencing the visually induced motion sickness based on the induction degree that has been obtained from the trained model generated by the model generating unit 306, but the induction degree estimating unit 307 is not limited to this. For example, the induction degree estimating unit 307 (the estimating unit) may determine whether or not the user using the HMD is experiencing the visually induced motion sickness by using the induction degree that has been obtained from Expression 1 in which the coefficients of the above-described βn (n=0, 1, 2, 3, 4, . . . ) are predetermined.

As described above, according to the first embodiment, the information processing apparatus 101 is able to estimate the occurrence of the visually induced motion sickness from the components of the HMD.

### Second Embodiment

In the first embodiment, the CPU 201 of the information processing apparatus 101 has used the HMD feature quantity 402, the content feature quantity 403, and the user feature quantity 404 as the explanatory variables to create the trained model, but the explanatory variables are not limited to these. For example, the CPU 201 of the information processing apparatus 101 may use factors such as the usage environment, whether various kinds of functions are turned on or off, or the presence or absence of a cooperation service as the explanatory variables. In addition, the CPU 201 of the information processing apparatus 101 may create a trained model by using only the HMD feature quantity 402. In addition, the CPU 201 of the information processing apparatus 101 may generate a trained model by using the HMD feature quantity 402 and the content feature quantity 403, or may generate a trained model by using the HMD feature quantity 402 and the user feature quantity 404.

### Third Embodiment

In the first embodiment and the second embodiment, the information processing apparatus 101 estimates in real time the occurrence of the visually induced motion sickness in the user 102 wearing the HMD, but the embodiments are not limited to this. In this regard, the information processing apparatus 101 may not be an HMD, but may be, for example, an electronic device such as a PC, a tablet, or a smartphone. In addition, the information processing apparatus 101 may obtain the induction degree of the visually induced motion sickness based on the conditions inputted by the user each time the user inputs, rather than estimating the occurrence of the visually induced motion sickness in real time. For example, in the case of wanting to list HMDs that are less likely to cause the visually induced motion sickness for a specific user, the CPU 201 of the information processing apparatus 101 uses HMD configuration information of a plurality of HMDs, which are candidates, and user information of the specific user as the explanatory variables to perform obtaining of the induction degree. Thereafter, the CPU 201 (a sorting unit) of the information processing apparatus 101 sorts the HMDs according to the obtained numerical values of the induction degree, and creates a list of the HMDs in order of least likely to cause the visually induced motion sickness. Furthermore, the CPU 201 of the information processing apparatus 101 causes the output unit 308 to display the list of the sorted HMDs on the display unit 206.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017796, filed on Feb. 8, 2024, which is hereby incorporated by reference herein in its entirety.

What is claimed is:

1. An information processing apparatus comprising one or more processors and/or circuitry configured to:
execute an HMD information obtainment processing that obtains HMD configuration information indicating a relationship between components of an HMD and a visually induced motion sickness;
execute an estimation processing that estimates whether or not a user using the HMD experiences the visually induced motion sickness based on an induction degree of the visually induced motion sickness obtained by using the HMD configuration information; and
execute an output processing that outputs an estimation result obtained in the estimation processing.

2. The information processing apparatus according to claim 1, wherein
the one or more processors and/or circuitry is further configured to
execute a measurement obtainment processing that obtains biological effect information in which biological effects of the visually induced motion sickness on the user have been indicated as results of psychological or physiological measurements; and
execute a model generation processing that generates a trained model by using the HMD configuration information and the biological effect information as learning data to perform training, and
in the estimation processing, the induction degree of the visually induced motion sickness is obtained by inputting the HMD configuration information into the trained model.

3. The information processing apparatus according to claim 2, wherein
the one or more processors and/or circuitry is further configured to
execute an operation obtainment processing that obtains input information indicating whether or not the user is experiencing the visually induced motion sickness based on an operation input performed by the user; and
execute a model update processing that updates the trained model by using the input information.

4. The information processing apparatus according to claim 2, wherein
the biological effect information includes information indicating the result of the measurement of at least one of an SSQ score, a body temperature, a heart rate, the number of times of eye closures, a skin moisture content, brain waves, and a mismatch between an eye movement and a video image.

5. The information processing apparatus according to claim 1, wherein
the one or more processors and/or circuitry is further configured to execute a content information obtainment processing that obtains content information indicating a relationship between an XR content displayed on the HMD and the visually induced motion sickness, and
in the estimation processing, the induction degree of the visually induced motion sickness is obtained by also using the content information.

6. The information processing apparatus according to claim 5, wherein
the one or more processors and/or circuitry is further configured to
execute a measurement obtainment processing that obtains biological effect information in which biological effects of the visually induced motion sickness on the user have been indicated as results of psychological or physiological measurements; and
execute a model generation processing that generates a trained model by using the HMD configuration information, the content information, and the biological effect information as learning data to perform training, and
in the estimation processing, the induction degree of the visually induced motion sickness is obtained by inputting the HMD configuration information and the content information into the trained model.

7. The information processing apparatus according to claim 6, wherein
the one or more processors and/or circuitry is further configured to
execute an operation obtainment processing that obtains input information indicating whether or not the user is experiencing the visually induced motion sickness based on an operation input performed by the user; and
execute a model update processing that updates the trained model by using the input information.

8. The information processing apparatus according to claim 6, wherein
the biological effect information includes information indicating the result of the measurement of at least one of an SSQ score, a body temperature, a heart rate, the number of times of eye closures, a skin moisture content, brain waves, and a mismatch between an eye movement and a video image.

9. The information processing apparatus according to claim 5, wherein
the content information includes information indicating a relationship between the visually induced motion sickness, and at least one of a frame rate, a degree of a video image shake, a viewpoint type, a movement method of an avatar, a moving speed of the avatar, a moving acceleration of the avatar, and presence or absence of a visually induced motion sickness reduction function when the avatar moves.

10. The information processing apparatus according to claim 1, wherein
the one or more processors and/or circuitry is further configured to
execute a content information obtainment processing that obtains content information indicating a relationship between an XR content displayed on the HMD and the visually induced motion sickness; and
execute a user information obtainment processing that obtains user information indicating a relationship between the user and the visually induced motion sickness, and
in the estimation processing, the induction degree of the visually induced motion sickness is obtained by also using the content information and the user information.

11. The information processing apparatus according to claim 10, wherein
the one or more processors and/or circuitry is further configured to
execute a measurement obtainment processing that obtains biological effect information in which biological effects of the visually induced motion sickness on the user have been indicated as results of psychological or physiological measurements; and
execute a model generation processing that generates a trained model by using the HMD configuration information, the content information, the user information, and the biological effect information as learning data to perform training, and
in the estimation processing, the induction degree of the visually induced motion sickness is obtained by inputting the HMD configuration information, the content information, and the user information into the trained model.

12. The information processing apparatus according to claim 11, wherein
the one or more processors and/or circuitry is further configured to
execute an operation obtainment processing that obtains input information indicating whether or not the user is experiencing the visually induced motion sickness based on an operation input performed by the user; and
execute a model update processing that updates the trained model by using the input information.

13. The information processing apparatus according to claim 11, wherein
the biological effect information includes information indicating the result of the measurement of at least one of an SSQ score, a body temperature, a heart rate, the number of times of eye closures, a skin moisture content, brain waves, and a mismatch between an eye movement and a video image.

14. The information processing apparatus according to claim 10, wherein
the content information includes information indicating a relationship between the visually induced motion sickness, and at least one of a frame rate, a degree of a video image shake, a viewpoint type, a movement method of an avatar, a moving speed of the avatar, a moving acceleration of the avatar, and presence or absence of a visually induced motion sickness reduction function when the avatar moves.

15. The information processing apparatus according to claim 10, wherein
the user information includes information indicating a relationship between the visually induced motion sickness, and at least one of a head movement amount, a head rotation amount, an age, a race, a health condition, a use frequency of the HMD, and a use time of the HMD.

16. The information processing apparatus according to claim 1, wherein
the one or more processors and/or circuitry is further configured to execute a user information obtainment processing that obtains user information indicating a relationship between the user and the visually induced motion sickness, and
in the estimation processing, the induction degree of the visually induced motion sickness is obtained by also using the user information.

17. The information processing apparatus according to claim 16, wherein
the one or more processors and/or circuitry is further configured to
execute a measurement obtainment processing that obtains biological effect information in which biological effects of the visually induced motion sickness on the user have been indicated as results of psychological or physiological measurements; and
execute a model generation processing that generates a trained model by using the HMD configuration information, the user information, and the biological effect information as learning data to perform training, and
in the estimation processing, the induction degree of the visually induced motion sickness is obtained by inputting the HMD configuration information and the user information into the trained model.

18. The information processing apparatus according to claim 16, wherein
the user information includes information indicating a relationship between the visually induced motion sickness, and at least one of a head movement amount, a head rotation amount, an age, a race, a health condition, a use frequency of the HMD, and a use time of the HMD.

19. A control method for an information processing apparatus, the control method comprising:
an HMD information obtaining step of obtaining HMD configuration information indicating a relationship between components of an HMD and a visually induced motion sickness;
an estimating step of estimating whether or not a user using the HMD experiences the visually induced motion sickness based on an induction degree of the visually induced motion sickness obtained by using the HMD configuration information; and
an output step of outputting an estimation result obtained in the estimating step.

20. A non-transitory computer-readable storage medium storing a program for causing a computer to execute a control method for an information processing apparatus, the control method comprising:
an HMD information obtaining step of obtaining HMD configuration information indicating a relationship between components of an HMD and a visually induced motion sickness;
an estimating step of estimating whether or not a user using the HMD experiences the visually induced motion sickness based on an induction degree of the visually induced motion sickness obtained by using the HMD configuration information; and
an output step of outputting an estimation result obtained in the estimating step.
